(19) United States
(12) Patent Application Publication
(10) Pub. No.: US 2014/0050917 A1
(43) Pub. Date: Feb. 20, 2014

(54) LAMINATES OF UV CURABLE ACRYLATES AND SILANE PRIMERS HAVING GOOD ADHESION TO SILICEOUS SURFACES

(71) Applicants: ANAND UPADHYAYA, KENT, OH (US); STEPHANIE CASTRO, WESTLAKE, OH (US); MOCHERLA K.K. RAO, HUDSON, OH (US)

(72) Inventors: ANAND UPADHYAYA, KENT, OH (US); STEPHANIE CASTRO, WESTLAKE, OH (US); MOCHERLA K.K. RAO, HUDSON, OH (US)

(73) Assignee: NANOFILM LTD., VALLEY VIEW, OH (US)

(21) Appl. No.: 13/585,177

(22) Filed: Aug. 14, 2012

(51) Int. Cl. C09D 183/07; B32B 17/10

(52) U.S. Cl. 428/336; 428/447; 428/337; 524/547

(57) ABSTRACT

A laminate composition includes a UV curable acrylate adhered to an acrylated silane primer having at least one terminal halogen group with the silane primer being adhered to a siliceous surface. Strong chemical bonds are formed between the primer and the siliceous surface as well as between the primer and the UV curable coating.

### FIELD OF INVENTION

The present invention relates to a composition and laminate of a UV curable coating comprising acrylic oligomers and/or polymers on a very thin silane layer that is strongly adhered to a siliceous surface. The silane layer acts as a primer with respect to the UV curable coatings. The primer formulation comprises a mixture of a methacrylated/acrylated functional halo silane in a compatible solvent that when applied to the siliceous surface will covalently bond thereto and create a very thin siloxane film on the surface.

### BACKGROUND OF THE INVENTION

UV curable coatings based on acrylate polymers are known in the art. Some of the benefits they provide are scratch and mar resistance, chemical (solvent) resistance, and resistance to UV radiation. Other benefits, especially when compared to the conventional thermal cure coatings, are lower processing costs, faster cure times and reduced or no volatile emissions during processing.

However, acrylic resin based coatings often have poor adhesion to glass or other siliceous surface as they need to soften and penetrate the surface to bond to the underlying materials and create an inter penetrating network (IPN). Due to its relatively hard impervious surface, this is generally not possible with glass, which causes poor adhesion of the coating and very poor durability.

U.S. Pat. Nos. 4,719,146; 4,477,529; 4,198,465; 2008/0255263 A1; 200710197676 A1 and 6,100,313 all disclose coating compositions containing UV curable acrylic resins that are applied to only plastic substrates.

In practical terms, coating glass with acrylic colorants/inks is therefore generally not possible without a primer. Most of the primers in use or invented require either multiple components or long application curing times, or relatively complicated application methods to the glass, such as set forth in the following paragraphs.

U.S. Pat. No. 5,895,721 discloses the composition of a primer to improve adhesion between an ionomer and glass. The ionomer is an ethylene/carboxylic acid copolymer or an alpha olefin/carboxylic acid copolymer, not an UV curable acrylate based resin.

U.S. Pat. No. 6,136,382 teaches the use of a methacryloxypropyl-functionalized silane primer to enhance adhesion between glass and a radiation (UV) curable ink. The patent discloses a primer composition that comprises 75% to 99.99% of a solvent, preferably water, and 0.01 to 20% of silane that is an alkoxysilane among other types and has a variety of head groups such as acrylates and methacrylates. Silanol formation occurs when the alkoxysilane is hydrolyzed by the water, and this step is necessary in order for the silane to bond with hydroxyl groups of the inorganic substrate. The most preferable pH range is 3.8 to 4.3, which can be achieved by addition of acid. When the article is heated to 160° F. to 170° F. after it has been sprayed with primer formulation, the silanol compound more readily reacts with the glass surface. The primer solution also requires heat to bond to the glass substrate. Additionally, the presence of acid in the formulation makes it undesirable with respect to safe handling.

U.S. Pat. No. 6,765,055 discloses a primer composition comprising an adhesion promoter and an acrylic based film forming resin. The adhesion promoter comprises a silane compound that is a reaction product between a polyisocyanate and a silane coupling agent. The purpose of this primer is to bond automotive glass windows to a metal with a urethane based sealant. This invention is also complex, requiring (1) carrying out a reaction between a polyisocyanate and a silane compound (2) having an acrylic based resin in the formulation and (3) a long curing time of the order of days.

U.S. Pat. No. 7,638,199 describes forming a primer layer on glass surfaces that comprises the hydrolysis product of a hydrolyzable silane that has an alkylene group and the hydrolysis product of a hydrolyzable zirconium compound or titanium compound. This invention is complicated because it utilizes hydrolysis and polycondensation of a silane and zirconium compound. For that purpose it is necessary to maintain pH of the solution at 2 or lower. This low pH is undesirable from the point of view of safe handling.

U.S. Patent Publication No. 200810269452 (A1) discloses a primer composition for glass and other transparent surfaces. The primer comprises an adhesion promoter, which is an adduct prepared by the reaction of at least one aromatic polyisocyanate compound with an active hydrogen moiety of an organofunctional silane. The invention however is complex, requiring; (1) carrying out a reaction between an aromatic polyisocyanate compound and organofunctional silane and (2) a lengthy curing process after a primer is applied onto a substrate: e.g. 7 days at 23° C. and 50% RH.

There is thus a need for a UV curable acrylic based coating or laminate that can be applied on glass or glass-like substrates with a suitable primer that promotes the adhesion of UV curable acrylic coatings to glass. The application of the primer of the present invention is a simple process at room temperature, has a short cycle time, and is environmentally friendly. The process for manufacturing the primer formulation is simple and can be scaled up quickly to commercial quantities utilizing readily available equipment. Other desirable attributes of the present invention are that the treatment and curing of the formulations are adaptable to existing commercial coatings and surface treatment processes such as assembly line manufacturing.

### SUMMARY OF THE INVENTION

The present invention relates to a UV curable acrylic coating or laminate for glass or glass-like substrates that comprises 1) a primer that is so thin that it does not interfere with optical properties of substrate and has a fast ambient temperature cure, and 2) a UV curable acrylic resin or mixture. Other advantages of the primer include an environmentally friendly composition for glass surfaces that can be applied by simple application processes such as spraying, dipping, knife-edge coating, etc., at room temperature and the formation of a very thin, optically clear chemical bound uniform coating layer.

Another aspect of the invention is that the formulation is believed not to be carcinogenic or mutagenic to humans or animals.

Unlike previous inventions, the present invention focuses on using a methacrylated/acrylated silane having at least one terminal halogen group as a primer composition that is applied on siliceous substrates before applying a UV curable acrylic based coating. By selecting a suitable silane in combination with an inert carrier material it is possible to create a uniform, very thin chemically bound film on the glass surface. The terminal groups on the silane methyacrylates and/or acrylates are thus available to selectively react with the monomers/components of UV curable acrylic coatings and/or inks during the curing process. The primer will also create adhesion between any UV-curable clear coating, ink or opaque coating that contains acrylate or methacrylate groups in its formulation. The primer of the present invention does not require any prior reaction steps before application to the glass. Preparation of the glass before “priming” is achieved simply by cleaning with commercially available cleaners such as WINDEX® Outdoors, WINDEX® Original etc. or by commercially known methods such as cleaning in an alkali bath or buffing with cerium oxide paste.

The primer formulations comprise a physical mixture of generally two key components: a methacrylated/acrylated silane having at least one halogen terminal group and an inert carrier solvent. The formulation is prepared by mixing the silane into the solvent.

While not wishing to be bound by theory, it is believed that the silane will form a permanent covalent bond with the substrate surface, thus forming a thin and uniform silane primer layer and/or film. That is, a layer having a thickness of from about 1 to about 1000 nm, desirably from about 1 to about 200 nm, and preferably from about 1 to about 50 nm. This very thin layer is achieved by utilizing the mechanism of self-assembly as in silane chemistry.

An important component of the primer formulation is an inert organic solvent that will prevent premature reactions or self-polymerization of the silane during transportation and storage and yet will facilitate reactions only when applied to the glass surface. The solvent must be capable of being easily removed from the glass surface to permit the reaction of the silane to the bound hydroxyls on the glass surface. The organic solvent should be aprotic so that it does not react with the halogenated silane, is non-hazardous, non-flammable and readily biodegradable. More specifically the solvent should not be considered hazardous as per OSHA 29 CFR 1910.1200. The solvent should have good HMIS scale ratings (i.e. less than or equal to 2 out of 4) i.e. Health<=1, Flammability<=2 and Reactivity=0. Wherein the lower the scale, the better. Two other desirable parameters are a high flash point (>=60° C.) and a high boiling point (>=200° C.). Another important parameter is it should not be hygroscopic so that the formulation does not readily absorb moisture from the environment and prematurely react with the halogen groups of the primer.

A laminate comprises a silane primer layer adhered to a siliceous substrate, said silane primer derived from a compound comprising an acrylated or methacrylated silane having at least one terminal halogen.

Another laminate comprises a silane primer layer derived from a compound comprising an acrylated or methacrylated silane having at least one terminal halogen and a UV cured acrylic resin coating that resides on said primer layer.

The silane primer solution comprises at least one silane compound comprising an acrylated or methacrylated silane having at least one terminal halogen and at least one organic solvent.

### DETAILED DESCRIPTION OF THE INVENTION

The present invention relates to laminates comprising a primer layer adhered to a siliceous surface and/or a UV curable acrylic coating adhered to the primer. The primer is a silane compound (molecule) having at least one terminal halogen group that rapidly cures to a siliceous substrate such as glass and to a top coating comprising UV curable acrylic polymers. The silane compound also contains an acrylate or methacrylate group so that it is able to react or condense with monomers/oligomers present in acrylic resin compositions under UV radiation. The silane compound contains the acrylate or methacrylate functional group at one end of the molecule and the other end contains a silicon atom that is preferably bonded to three halogen atoms.

More specifically, the silane primer compound can include:
Any silane that contains one or more acrylate groups at one end of the silane.
Any silane that contains one or more methacrylate groups at one end of the silane.
The silane preferably contains exactly one acrylate or methacrylate group in the head group.
The silane can contain an acryloxy or methacryloxy head group.
The silane preferably contains a reactive end group of the formula Si—(X)₃ where at least one X is a halogen such as a F, Cl, Br or I group.

The silane primer compounds of the present invention have of the general formula:

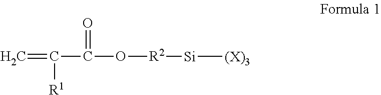

where, R¹ is a hydrogen or a methyl group, R² can be one of cyclo alkyl, alkylene, aryl or alkoxy groups or any combination thereof having a total of from 1 to about 12 carbon atoms. Preferably it is an alkylene group and even more preferably it is an alkylene group having from about 1 to about 10 carbon atoms. X can be fluorine, chlorine, bromine, iodine, methoxy, ethoxy, isopropoxy, methyl, or ethyl group. However, at least one X must be halogen. Examples of suitable silane primer compounds include methacryloxypropyldimethyl chlorosilane, methacryloxypropylmethyldichlorosilane, methacryloxypropyltrichlorosilane, acryloxypropyldimethylchlorosilane, acryloxypropylmethyldtichlorosilane, acryloxypropyltrichlorosilane, methacryloxybutyltrichlorosilane, methacryloxyhexyltrichlorosilane, methacrloxydecyltnchlorosilane, methacryloxybhexutylmethyldichlorosilane, methacryloxyhexylmethydichlorosilane, methacryloxydecylmethyldichlorosilane, acryloxybutyltrichlorosilane, acryloxyhexyltrichlorosilane, acryloxydecyltrichlorosilane, acryloxybutyldimethylchlorosilane, acryloxyhexyldimethylchlorosilane, acryloxydecyldimethylchlorosilane, methacryloxypropyldimethyl iodosilane, methacryloxypropylmethyldiiodosilane, methacryloxypropyltriiodosilane, methacryloxypropyldimethylbromosilane, methacryloxypropylmethyldibromosilane, methacryloxypropyltribromosilane, or any combination thereof. Among all these methacryloxypropyltrichlorosilane is especially preferred. One reason is that the trichloro functional group provides easy and effective grafting to siliceous substrates.

In preparing the primer composition or solution, the silane compound is mixed with the carrier solvent under inert, moisture-free conditions such as under an inert gas, e.g. argon or nitrogen. Any method of mixing such as magnetic stirring, overhead stirring etc. can be used provided that the apparatus and containers are blanketed under the inert gas.

The one or more carrier solvents are hydrocarbon and may or may not contain an aromatic group. Important aspects of the solvent are low toxicity and low viscosity. Also, care must be taken to dehydrate the solvent before using. Methods of solvent drying are known to those skilled in the art and include storing the solvent over dessicant beads, distilling the solvent from dessicant beads, or distilling the solvent over a chemical drying agent. Preferably solvents that match the calculated Hildebrand solubility parameter of the selected silanes are used.

It is an important aspect of the present invention that the silane primer solution, i.e. silane compound and solvent, be free of water since the water will react with the silane groups and produce silanol groups which tend to react with each other and render the primer useless, and also will react to produce hydrochloric acid gas which is of course detrimental. By the term “free of” it is meant that if any water is present in the primer solution, the amount thereof is generally less than about 10 parts per million, desirably less than about parts per million, and preferably less than about 1 part per million parts by weight of the primer solution, with no water being preferred.

Another important aspect of the present invention is that the primer solution, i.e. silane compound and solvent, is generally free of silanol compounds since they form a weak bond with any siliceous substrate. If any such compounds are present the amounts thereof are generally less than about 0.1 part by weight, desirably less than about 0.01 part by weight, and preferably less than about 0.001 part by weight and most preferably nil, that is no parts by weight of silanol per 100 parts by weight of the primer solution.

The carrier solvents preferably can be any of the following:

A hydrocarbon solvent that is either an alkane or an isoalkane that has from about 5 to about 30 carbon atoms per molecule, desirably from about 5 to about 20, and preferably from about 5 to about 10 carbon atoms per molecule, an aromatic or an alkyl substituted aromatic, or an alkoxy aromatic solvent having a total of from 6 to about 20 carbon atoms; or an aromatic ester having from about 5 to about 15 carbon atoms; or a mixture of the above solvents. Examples of suitable hydrocarbon solvents that form the primer solution include methyl benzoate, ethyl benzoate, propyl benzoate, butyl benzoate, ISOPAR L,ISOPAR V, Solvesso 150, Solvesso™ 150 ND, Solvesso 200, Solvesso™200 ND, xylene, toluene, benzene, decane, hexane, heptane, etc. Preferred Solvents are methyl benzoate, ethyl benzoate, ISOPAR™ L, ISOPAR™ M, Solvesso™ 200 and Solvesso™ 200 ND.

It was however unexpectedly discovered that a very great many solvents with very great variation in solubility parameters were suitable for use as a component of primer in combination with specific silane. The only conditions needed were that solvents were aprotic and do not contain water etc. that might react with silane.

The silane primer solution of the present invention generally contains from about 0.01 or about 0.1 to about 20%, desirably from about 0.5 to about 10%, and preferably from about 1 to about 5% by weight of the silane compound based upon the total weight of the one or more silane compounds and the one or more solvents.

It was unexpectedly observed that even when silane concentration was below 0.1 wt % in the primer formulation, after its application excellent adhesion was observed between glass panel and UV curable coating. Those experienced in the art well know that efficacies at such low concentrations are very unusual. Moreover, the silane compounds of the present invention have the unique ability to form a self-assembled coating on the siliceous substrate and form a strong affinity thereto.

In addition to the silane compound and the solvent, the invention can include rheology modifying compounds, such as VASELINE® (white petrolatum), or polydimethylsiloxane or oligomers free of any silanol groups, or unsaturated groups capable of being hydrosilated. Optionally, temporary catalyst inhibitors, fillers, pigments, dyes, adhesion promoters or thixotropic agents can be added in suitable or conventional amounts. An advantage of the present invention is that the use of nonionic surfactants is not required.

The primer components of the present invention are thoroughly mixed by methods commonly known in the art. Stirrers can be of many configurations and types such as a turbine, propeller, single axis or multi-axial, tangential, circulatory, rotary or magnetic and so on. Once thoroughly mixed, the formulations are ready to be used. The silane solution has a long shelf life such as at least about 5 years and desirably at least about 1 year provided the formulation is stored under an inert gas such as nitrogen or argon.

The substrates to be coated with the primer are siliceous articles such as glasses, ceramic, porcelain and the like, and desirably various types of glass such as sodium glass, e-glass, borosilicate glass, aluminosilicate glass and the like. The primers of the present invention have good adhesion to the siliceous substrates since they form a strong chemical bond therewith.

The substrate is desirably cleaned by utilizing an alkaline commercial cleaning bath composition such as made by SCL International (Archamps, France), or GRISIRON 7903, made by Henkel corporation, Madison Heights, Mich. The substrate is then dried in an oven above ambient temperatures such as about 40° C. to remove moisture. In the course of evaluating the formulations of the present invention, clean float 3″×3″ glass panels were utilized, although the inventive formulations are not limited to treatment of glass surfaces.

Once the surfaces of the substrate to be coated have been cleaned and dried, the formulations of the present invention are applied as by wiping the primer solution thereon. Alternatively, the formulations can also be sprayed on the surface, dipped, submerged, brushed or coated on the substrate. With respect to float glass panels, either the “tin oxide” or non-tin oxide side can be coated with equal efficacy.

After the primer solution has been applied, the substrate (panel) is allowed to cure at ambient temperatures, e.g. from about 10° C. to about 50° C., desirably from about 10° C. to about 30° C., such as from about 1 to about 2 minutes. An important and convenient aspect of the present invention is that cure can occur at room temperature, which is at about 15° C. to about 27° C. After cure, the sample can be buffed with a non-reactive cloth or paper, such as a KIMWIPE®, or it can be rinsed with a commercial lens cleaner such as, for example, a product available commercially by the name of CLARITY CLEAN IT® manufactured by Nanofilm Ltd. of Valley View, Ohio. The substrate is then ready to be treated with any conventional UV curable acrylic coating in any conventional manner such as by spraying, dipping, brushing, etc.

The UV curable coating that adheres to the primer can generally be any UV curable polymer and desirably any polymer derived from acrylic or methacrylic based monomers having from 1 to about 6 ester groups e.g. mono, di, tri, tetra, penta and hexa functional acrylate or methacrylate monomers wherein each ester group, independently, has from about 2 to about 15 carbon atoms and desirably is either an alkyl or alkoxy including for example, 2(2-Ethoxyethoxy)ethyl acrylate, diethylene glycol diacrylate, ethoxylated trimethylolpropane triacrylate, trimethylolpropane tetraacrylate, dipentaerythritol pentaacrylate etc., or any combination thereof. UV curable coating can also contain oligomers of the above mentioned acrylic monomers with monomers having epoxy, urethane, or silicone groups, as for example various epoxy acrylates, epoxy methacrylates, urethane acrylates, urethane methacrylates, silicone acrylates, and the like. The UV curable coatings can also comprise blends of above mentioned monomers and oligomers. In addition to the above mentioned monomers and oligomers, the UV curable coatings can also contain inorganic nanoparticles such as silica and alumina nanoparticles, etc. The nanoparticle size can be from about 10 to about 40 nanometers. The nanoparticles may present between 1 to 20 wt % based upon the total weight of the UV curable coatings.

The UV curable coatings can also contain pigments commonly known in the art inclusive but not limited to Han Purple, Ultramarine, Cobalt Blue, Cerulean Blue, cobalt(II) stannate, Egyptian Blue, Han Blue, Prussian Blue, Cadmium Green, Viridian, Chrome Green, Paris Green, Scheele's Green, Orpiment, Cadmium Yellow, Chrome Yellow, Cadmium Orange, Chrome Orange, Cadmium Red, Sanguine, Venetian Red, Oxide Red, Raw Umber, Carbon Black, Ivory Black, Titanium White, Zinc White etc; and dyes such as Alcian yellow GXS, Alizarin, Alizarin red S, Alizarin yellow GG, Alizarin yellow R, Azophloxin, Bismarck brown R, Bismarck brown Y, Brilliant cresyl blue, Congo red, Crystal violet, Gentian violet, Janus green, Martius yellow, Meldola blue, Methyl orange, Methyl red, Sudan II etc.

The UV curable coating can be applied on the primer treated substrates by methods known in the art such as dip coating, flow coating, wire wound rods, doctor knife etc. The UV curable coating can be cured by the methods commonly known in the art.

The invention will be better understood by reference to the following Examples that serve to illustrate, but not to limit the invention.

### EXAMPLES

### Methodology

The hydrophobicity, or water repellent property, of treated glass panels was evaluated by measuring the static water contact angles on the surface. The oleophobicity, or oil repellent property, was evaluated by measuring the static mineral oil contact angles. All measurements were made with a Ramé-Hart goniometer (Ramé-Hart Instrument Company, Netcong, N.J., Model #100-00-115).

The optical properties (% Haze and % Transmission) of the substrates before and after coating were measured by a well known test utilizing a HAZE-GARD® meter made by BYK Gardner (Columbia, Md.).

Adhesion of the coating to the glass was tested by cross-hatch method (ASTM 03359-02) wherein the coating was cut in a grid pattern (5-10 mm wide), having 6 horizontal and 6 vertical rows, with a razor blade. Transparent Scotch #600 tape (¾″ wide) was applied to the crosshatched area. The tape was removed quickly and parallel to the surface. This tape application and removal was repeated 2 more times. The coating was examined for loss of pieces along the crosshatched area and rated by the amount of coating lost. A coating where 100% of the coating was lost is rated “0”; a coating where 0% of the coating was lost is rated “5”.

### Example 1

The inventive formulation was prepared by physically mixing 100 grams of ISOPAR™ M (From ExxonMobil Chemical Company, Houston, Tex.) and 5 grams of 3-methacryloxypropyltrichlorosilane. 3″×3″ clear float glass samples were cleaned in a caustic bath. The non-tin oxide side of each glass sample was determined by exposing it to UV light. About 0.5 ml of the formulation was applied onto the non-tin oxide side of the panel by means of a KIMWIPE®, and the panels were allowed to stand at ambient conditions (25° C., ˜50% RH) for a period of 1 minute. After one minute, the excess formulation was removed by buffing with a KIMWIPE®.

### Example 2

The inventive formulation was prepared by physically mixing 100 grams of ISOPAR™ M and 3 grams of 3-methacryloxypropyltrichlorosilane. The same procedure was used to coat and cure the samples as in Example 1.

### Example 3

The inventive formulation was prepared by physically mixing 100 grams of ISOPAR™ M and 1 gram of 3-methacryloxypropyltrichlorosilane. The same procedure was used to coat and cure the samples as in Example 1.

### Example 4

The inventive formulation was prepared by physically mixing 100 grams of ISOPAR™ M and 0.5 gram of 3-methacryloxypropyltrichlorosilane. The same procedure was used to coat and cure the samples as in Example 1.

### Example 5

The inventive formulation was prepared by physically mixing 100 grams of ISOPAR™ M and 0.05 gram of 3-methacryloxypropyltrichlorosilane. The same procedure was used to coat and cure the samples as in Example 1.

### Example 6

The inventive formulation was prepared by physically mixing 100 grams of methyl benzoate (Sigma-Aldrich, St. Louis, Mo.) and 3 grams of 3-methacryloxypropyltrichlorosilane. The same procedure was used to coat and cure the samples as in Example 1.

### Example 7

The inventive formulation was prepared by physically mixing 100 grams of propylene carbonate (Sigma-Aldrich, St. Louis, Mo.) and 3 grams of 3-methacryloxypropyltrichlorosilane. The same procedure was used to coat and cure the samples as in Example 1.

TABLE 1
Adhesion of UV curable resin on panels treated with
Formulations of Experiment 1-7.

| | Amount | | | OCA | Adhesion |
|---|---|---|---|---|---|
| | of Silane | | WCA | (of | (of cured C2 |
| Example | (wt %) | Solvent | (of primer) | primer) | coating) |
| 1 | 5 | Isopar M | 68 | 19.5 | 5 |
| 2 | 3 | Isopar M | 67 | 17 | 5 |
| 3 | 1 | Isopar M | 69 | 17 | 5 |
| 4 | 0.5 | Isopar M | 69 | 16 | 5 |
| 5 | 0.05 | Isopar M | 65 | 16 | 5 |
| 6 | 3 | Methyl | 64 | 17.5 | 5 |
| | | benzoate | | | |
| 7 | 3 | Propylene | 61 | 13.5 | 5 |
| | | carbonate | | | |
| Control | — | — | 0 | 7 | 0 |

*Values taken before applying UV curable coating (C2)

A UV curable acrylate resin (C2) was applied onto the samples treated in examples 1, 2, and 3 by means of a #3 wire-wound rod (RD Specialties, Webster, N.Y.). The coatings were cured by passing through Fusion UV curing apparatus (6 inch, 300 WPI, H bulb, at 56 fpm) until coatings were hard and non-tacky.

It can be seen from Table 1 that panels treated with the inventive formulations have excellent adhesion to the acrylate resin after curing. Untreated glass had no adhesion whatsoever. Also, the concentration of silane in the formulation had no substantial effect on the adhesion and on oil and water contact angles, nor did the type of the carrier solvent.

Five UV curable resins, representative of UV curable hard coats, were prepared and consisted of SR-238 or SR-508, both difunctional acrylated monomers, SR230, a diethyleneglycol diacrylate, CN133, a low viscosity triacrylate oligomer, SR-494, a tetrafunctional acrylated monomer, CN-2301, a high molecular weight polyester acrylate oligomer, CN963A80 which is an aliphatic urethane acrylate oligomer blended with tripropyleneglycol diacrylate and CN964E75 which is an aliphatic urethane acrylate oligomer blended with ethoxylated (3) trimethylolpropane triacrylate (Table 2). All were obtained from Sartomer (Exton, Pa.). The formulations also contained benzophenone, a common photoinitiator.

TABLE 2
Representative UV curable resins

| | C-2 | C-3 | C-4 | C-5 | C-6 |
|---|---|---|---|---|---|
| SR238 | 5 | | | | |
| SR508 | | 5 | | | |
| SR494 | 2 | 2 | | | |
| CN2301 | .5 | .5 | | | |
| SR230 | | | 7.6 | 7.6 | 7.6 |
| CN133 | | | 1.7 | 1.7 | |
| CN3103 | | | .3 | | .3 |
| CN963A80 | | | | .3 | |
| CN964E75 | | | | | 1.7 |
| Benzophenone | .5 | .5 | .5 | .5 | .5 |
| Adhesion to | 0 | 0 | 0 | 0 | 0 |
| unprimed glass | | | | | |
| Adhesion to primed | Example 8 | Example 9 | Example 10 | Example 11 | Example 12 |
| glass | 5 | 5 | 5 | 5 | 5 |

### Examples 8, 9, 10, 11, 12

The panels were treated with the formulation described in Example 2 and C-2, C-3, C-4, C-5, and C-6 resin (Table 2) was applied and cured using a Fusion UV curing apparatus as described after Table 1.

It can be seen from Table 2 that UV curable resins (C-2-C-6) have excellent adhesion to panels treated with the inventive formulation of Example 2. In absence of primer there was no adhesion.

Commercially available UV curable coatings on glass coated with and without primer were also tested.

### Example 10

The glass panels were treated with formulation described in Example 2 and then a commercially available UV curable UV Klear™ 310 (Exxene, Corpus Christi, Tex.) was applied as described after Table 1.

### Example 11

The glass panels were treated with formulation described in Example 2 and then a commercially available UV curable coating KZ-5700-CL (Allied Photochemical Inc., Kimball, Mich.) was applied as described after Table 1 except a #12 rod was used instead of #3 rod.

### Example 12

The glass panels were treated with formulation described in Example 2 and then a commercially available UV curable coating 518A (UVEXS, Sunnyvale, Calif.) was applied as as described after Table 1.

TABLE 3
Adhesion of various coatings to primer treated glass panel

| | Adhesion to Glass | Adhesion to primer |
|---|---|---|
| Coating | substrate | treated Glass substrate |
| UV klear ™ 310 | 0 | 5 |
| KZ-5700-CL | 0 | 5 |
| 518A | 0 | 5 |

It can be seen from Table 3 that all commercially available UV curable coatings failed to adhere to glass panels by themselves. However, after treatment with primer formulation mentioned in Example 2 excellent adhesion was obtained.

In accordance with the patent statutes, the best mode and preferred embodiments have been set forth; the scope of the invention is not limited thereto, but rather by the scope of the attached claims.

What is claimed is:

1. A laminate, comprising:
a silane primer layer adhered to a siliceous substrate, said silane primer derived from a compound comprising an acrylated or methacrylated silane having at least one terminal halogen.

2. The laminate of claim 1, wherein said silane compound has the formula 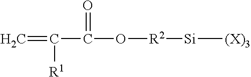
wherein R¹ is a hydrogen atom or a methyl group, R² is a cyclo alkyl, an alkylene, an aryl, or an alkoxy group, or any combination thereof, having a total of from about 1 to about 12 carbon atoms, and wherein at least one X is a halogen and the remaining one or two groups is a fluorine, chlorine, bromine, iodine, methoxy, ethoxy, isopropoxy, methyl or an ethyl group, or any combination thereof.

3. The laminate of claim 2, wherein said silane compound comprises methacryloxyalkylmethyldichlorosilane, methacryloxyalkyldimethylchlorosilane, methacryloxyalkyltrichlorosilane, acryloxyalkylmethyldichlorosilane, acryloxyalkyldimethylchlorosilane, acryloxyalkyltrichlorosilane, or methacryloxypropytrichlorosilane, or any combination thereof; wherein said siliceous substrate comprises a glass, a ceramic, or a porcelain, or any combination thereof; and wherein the thickness of said silane primer layer is from about 1 to about 1,000 nanometers, and wherein said silane primer layer is self-assembled.

4. The laminate of claim 1, wherein said silane compound comprises methacryloxypropyldimethylchlorosilane, methacryloxypropylmethyldichlorosilane, methacryloxypropyltrichlorosilane, acryloxypropyldimethylchlorosilane, acryloxypropylmethyldichlorosilane, acryloxypropyltrichlorosilane, methacryloxybutyltrichlorosilane, methacryloxyhexyltrichlorosilane, methacrloxydecyltrichlorosilane, methacryloxybutylmethyldichlorosilane, methacryloxyhexylmethyldichlorosilane, methacryloxydecylmethyldichlorosilane, acryloxybutyltrichlorosilane, acryloxyhexyltrichlorosilane, acryloxydecyltrichlorosilane, acryloxybutyldimethylchlorosilane, acryloxyhexyldimethylchlorosilane, acryloxydecyldimethylchlorosilane, methacryloxypropyldimethyliodosilane, methacryloxypropylmethyldiiodosilane, methacryloxypropyltriiodosilane, methacryloxypropyldimethylbromosilane, methacryloxypropylmethyldibromosilane, methacryloxypropyltribromosilane, or any combination thereof; wherein a thickness of said silane compound layer is from about 1 to about 200 nanometers; and wherein said silane compound is cured at a temperature of from about 10° C. to about 30° C.

5. The laminate of claim 4, wherein said silane compound is methacryloxypropyltrichlorosilane, methacryloxybutyltrichlorosilane, methacryloxyhexyltrichlorosilane, and acryloxybutyltrichlorosilane, wherein said siliceous substrate is glass, and wherein the thickness of said silane compound layer is from about 1 to about 50 nanometers; and wherein said silane compound is cured at a temperature of from about 15° C. to about 27° C.

6. A laminate, comprising:
a silane primer layer derived from a compound comprising an acrylated or methacrylated silane having at least one terminal halogen, and
a coating residing on said primer layer comprising a UV cured acrylic resin.

7. The laminate of claim 6, wherein said silane compound has the formula: 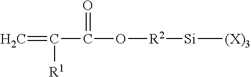
wherein R¹ is a hydrogen atom or a methyl group, R² is a cyclo alkyl, an alkylene, an aryl, or an alkoxy group, or any combination thereof, having a total of from about 1 to about 12 carbon atoms, and wherein at least one X is a halogen and the remaining one or two groups is a fluorine, chlorine, bromine, iodine, methoxy, ethoxy, isopropoxy, methyl or an ethyl group, or any combination thereof.

8. The laminate of claim 7, wherein said silane compound comprises methacryloxyalkylmethyldichlorosilane, methacryloxyalkyldimethylchlorosilane, methacryloxyalkyltrichlorosilane, acryloxyalkylmethyldichlorosilane, acryloxyalkyldimethylchlorosilane, acryloxyalkyltrichlorosilane, or methacryloxypropytrichlorosilane, or any combination thereof; wherein the thickness of said silane compound layer is from about 1 to about 1,000 nanometers, and wherein said silane compound is free of a silanol.

9. The laminate of claim 8, wherein said UV cured resin is derived from an acrylate or methacrylate monomer having from 1 to about 6 ester groups and wherein each ester group, independently, has from about 2 to about 15 carbon atoms, or said monomers or oligomers thereof with at least one urethane group, a silicone group, or an epoxy group, or any combination thereof, wherein the thickness of said silane compound layer is from about 1 to about 200 nanometers, and wherein said silane compound is cured at a temperature of from about 10° C. to about 50° C.

10. The laminate of claim 6, wherein said silane compound comprises methacryloxypropyldimethylchlorosilane, methacryloxypropylmethyldichlorosilane, methacryloxypropyltrichlorosilane, acryloxypropyldimethylchlorosilane, acryloxypropylmethyldichlorosilane, acryloxypropyltrichlorosilane, methacryloxybutyltrichlorosilane, methacryloxyhexyltrichlorosilane, methacrloxydecyltrichlorosilane, methacryloxybutylmethyldichlorosilane, methacryloxyhexylmethyldichlorosilane, methacryloxydecylmethyldichlorosilane, acryloxybutyltrichlorosilane, acryloxyhexyltrichlorosilane, acryloxydecyltrichlorosilane, acryloxybutyldimethylchlorosilane, acryloxyhexyldimethylchlorosilane, acryloxydecyldimethylchlorosilane, methacryloxypropyldimethyliodosilane, methacryloxypropylmethyldiiodosilane, methacryloxypropyltriiodosilane, methacryloxypropyldimethylbromosilane, methacryloxypropylmethyldibromosilane, methacryloxypropyltribromosilane, or any combination thereof;
and wherein said UV cured resin is derived from an acrylate or methacrylate monomer having from 1 to about 6 ester groups and wherein each ester group, independently, has from about 2 to about 15 carbon atoms, or said monomers or oligomers thereof with at least one urethane group, a silicone group, or an epoxy group, or any combination thereof; and wherein the thickness of said silane compound layer is from about 1 to about 200 nanometers.

11. The laminate of claim 10, wherein said silane primer is methacryloxypropyltrichlorosilane methacryloxybutyltrichlorosilane, methacryloxyhexyltrichlorosilane, and acryloxybutyltrichlorosilane; and wherein said UV curable polymer is diethylene glycol diacrylate, ethoxylated trimethylolpropane triacrylate, trimethylolpropane tetraacrylate, or dipentaerythritol pentaacrylate.

12. The laminate of claim 6, wherein said laminate is adhered to a siliceous substrate.

13. The laminate of claim 9, wherein said laminate is adhered to a glass substrate.

14. The laminate of claim 11, wherein said laminate is adhered to a glass substrate, and wherein said silane compound is self-assembled.

15. A silane primer solution, comprising:
at least one silane compound comprising an acrylated or methacrylated silane having at least one terminal halogen; and
at least one organic solvent.

16. The silane primer solution of claim 15, wherein said silane compound has the formula: 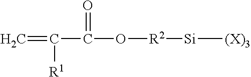
wherein R¹ is a hydrogen atom or a methyl group, R² is a cyclo alkyl, an alkylene, an aryl, or an alkoxy group, or any combination thereof, having a total of from about 1 to about 12 carbon atoms, and wherein at least one X is a halogen and the remaining one or two groups is a fluorine, chlorine, bromine, iodine, methoxy, ethoxy, isopropoxy, methyl or an ethyl group, or any combination thereof; and wherein the amount of said silane compound is from about 0.01 to about 20% by weight based upon the total weight of said at least one silane compound and said at least one organic solvent.

17. The silane primer solution of claim 16, wherein said solvent comprises an alkane or isoalkane having a total of from about 5 to about 30 carbon atoms; an aromatic or an alkyl substitute aromatic, or an alkoxy aromatic solvent having a total of from 6 to about 20 carbon atoms; or an aromatic ester having from about 5 to about 15 carbon atoms; or any combination thereof; and wherein the amount of said silane compound is from about 0.5 to about 10% by weight based upon the total weight of said silane compound and said solvent.

18. The silane primer solution of claim 17, wherein said silane compound comprises methacryloxypropyldimethylchlorosilane, methacryloxypropylmethyldichlorosilane, methacryloxypropyltrichlorosilane, acryloxypropyldimethylchlorosilane, acryloxypropylmethyldichlorosilane, acryloxypropyltrichlorosilane, methacryloxybutyltrichlorosilane, methacryloxyhexyltrichlorosilane, methacrloxydecyltrichlorosilane, methacryloxybutylmethyldichlorosilane, methacryloxyhexylmethyldichlorosilane, methacryloxydecylmethyldichlorosilane, acryloxybutyltrichlorosilane, acryloxyhexyltrichlorosilane, acryloxydecyltrichlorosilane, acryloxybutyldimethylchlorosilane, acryloxyhexyldimethylchlorosilane, acryloxydecyldimethylchlorosilane, methacryloxypropyldimethyliodosilane, methacryloxypropylmethyldiiodosilane, methacryloxypropyltriiodosilane, methacryloxypropyldimethylbromosilane, methacryloxypropylmethyldibromosilane, methacryloxypropyltribromosilane, or any combination thereof; and wherein a thickness of said silane primer layer is from about 1 to about 1,000 nanometers, and wherein the amount of said silane compound is from about 0.5 to about 10% by weight.

19. The silane primer solution of claim 18, wherein said primer is methacryloxypropyltrichlorosilane, methacryloxybutyltrichlorosilane, methacryloxyhexyltrichlorosilane, and acryloxybutyltrichlorosilane; and wherein the amount of said silane compound is from about 1.0 to about 5% by weight.

20. The silane primer solution of claim 17, wherein said primer solution is free of water, and wherein said primer solution is free of a silanol.

21. The silane primer solution of claim 19, wherein said primer solution contains less than about 5 parts by weight of water per million parts by weight of said silane compound and said solvent, and wherein said primer solution contains less than about 0.01 parts by weight of a silanol per every 100 parts by weight of said silane compound and said solvent.
